(19) United States
(12) Patent Application Publication
(10) Pub. No.: US 2007/0099645 A1
(43) Pub. Date: May 3, 2007

(54) Wireless communication terminal for controlling power of access probe using neighbor set list and method therefor

(76) Inventor: Seok Cheol Kim, Gyeonggi-do (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/443,902

(22) Filed: May 30, 2006

(30) Foreign Application Priority Data
Nov. 2, 2005 (KR) 10-2005-0104157

(51) Int. Cl. H04B 1/00; H04B 7/00

(52) U.S. Cl. 455/522; 455/63.2

(57) ABSTRACT

A wireless communication terminal having a power control function of an access probe using a neighbor set list includes a compensation value providing unit configured to provide a compensation value corresponding to the number of neighbor base stations, a control unit configured to transmit the compensation value provided from the compensation value providing unit into an access probe control unit, and an access probe control unit configured to control a power level of an access probe with the compensation value transmitted from the control unit.

### BACKGROUND OF THE INVENTION

1. Field of the Invention

The present invention generally relates to a wireless communication terminal for controlling a power level of an access probe using a neighbor set list and a method therefor. More specifically, the present invention relates to a wireless communication terminal and a method for controlling a power level of an access probe using a compensation table for storing a compensation value corresponding to the number of neighbor base stations and a neighbor set list for recording the number of the neighbor base stations in a Pseudo Noise (hereinafter, referred to as “PN”) overlapping region having a severe electric wave interference (e.g., over 2.5 dB) from the neighbor base stations.

2. Description of the Related Art

FIG. 5 is a diagram illustrating a call process of a general wireless communication terminal.

First, a power-up state refers to a state where a power source is applied and system information read in a flash memory is copied into a RAM.

Next, an initialization state refers to a state where a wireless communication terminal is booted on, and a pilot channel and a sync channel are received.

A MS idle state refers to a state where all system information is received to finish a normal operation and various services including voice communication is prepared while continuously receiving a paging channel, that is, the state to receive a call or process a control signal.

A system access state refers to a state for connecting to a system to make a call through an access channel or respond to a paging channel message.

A MS control on the traffic state refers to a state where a terminal is under a call.

A wireless communication terminal goes into the MS idle state or the MS control on the traffic state when finishing a specific operation at the access state. And A wireless communication terminal re-starts an initialization process when it does not receive a paging channel message at the MS idle state. The paging channel indicates an overhead message including system information.

When receiving the paging channel message, the wireless communication terminal may goes into a MS control on the traffic state through a paging channel or an access channel, and always re-starts the initialization process when the call is finished to receive a system time, a long code state and a paging channel message and reset them precisely.

Generally, when a mobile station makes a call into a base station in a CDMA (Code Division Multiple Access) system, the mobile station requests a call message into the base station with the access channel. In IS-95A/B and CDMA2000 1x spec, message transmission through the access channel is defined as “access”.

The access attempt is defined as the whole process where the mobile station transmits a message into the base station through the access channel and then the base station transmits a response message.

An access probe refers to one access channel transmission unit from a mobile station to a base station. And an access probe sequence refers to a sequence of one or more access probes. After outputting the access probe at an initially set power level, the mobile station increases a power level corresponding to a predetermined power increment pwr_step and then outputs the next access probe when it does not receive a response from the base station. After a specific number of access probes are transmitted, transmission is delayed for a predetermined time and then re-attempted.

Information on access probe transmission is included in an access parameter message of the paging channel. Specifically, the access parameter message includes information on a normal power nom_pwr, an initial power init_pwr and a power increment pwr_step used in the following equation 1 that represents the first transmission power of the access probe.
Tx(dBm)=−Rx−73+nom_{—}pwr+init_{—}pwr [Equation 1]

Of 4 classifications on the pilot strength, the neighbor set defines a PN code which may be a substitute for handoff not in an active set or a candidate set. As a result, the neighbor set stored in a neighbor set list results in the large amount of interference to the mobile station.

If the number of neighbor sets becomes larger, the neighbor sets results in large interference to the mobile station included in the active set and performance degradation of the mobile station. As shown in FIG. 1, each base station has multi frequency allocation and multi sector system. When a mobile station is located in an overlapping region (PN overlapping region) of three base stations, the mobile station is interfered with electric waves of neighboring cells.

In the following, a conventional method for controlling a power level of an access probe is described.

A mobile station which is in a communication region of a base station communicates periodically with the base station to receive a power increment (hereinafter, referred to as “PI”) value. When the base station does not receive an access probe outputted from a wireless communication terminal, the base station commands increase of the power level of the access probe by PI.

The wireless communication terminal outputs an access probe at a power level predetermined for call setup.

Thereafter, when the wireless communication terminal does not receive a response message, the power level of the access probe is increased by PI so that the access probe is outputted at the increased power level.

The call setup is succeeded when the wireless communication terminal receives the response message from the base station, and the call setup is failed when the wireless communication terminal does not receive the response message.

The above-described conventional method controls the power level of the access probe according to IS-95A/B or CDMA 2000 Spec without distinction of a strong electric field, a weak electric field and a PN overlapping region in access attempt.

As a result, when the call setup is attempted in poor Ec/Io (Energy of carrier/Interference of other's) value conditions by deteriorated channel condition and interference from other base stations in the PN overlapping region or the weak electric field, the standard power required for call setup in the base station is not satisfied as shown in graph (a) of FIG. 3 to cause a call setup fail.

### SUMMARY OF THE INVENTION

Various embodiments of the present invention are directed at providing a wireless communication terminal and a method for controlling a power level of an access probe using a neighbor set list for increasing a call setup success rate, by controlling a power level of an access probe using a compensation table for storing a compensation value corresponding to the number of neighbor base stations and a neighbor set list for recording the number of the neighbor base stations in a PN overlapping region having a severe electric wave interference (e.g., over 2.5 dB) from a neighbor base station.

According to one embodiment of the present invention, a wireless communication terminal having a power control function of an access probe using a neighbor set list comprises a compensation value providing unit configured to provide a compensation value corresponding to the number of neighbor base stations, a control unit configured to transmit the compensation value provided from the compensation value providing unit into an access probe control unit, and an access probe control unit configured to control a power level of an access probe with the compensation value transmitted from the control unit.

According to one embodiment of the present invention, a method for controlling a power level of an access probe using a neighbor set list in a wireless communication terminal comprises: providing a compensation value corresponding to the number of neighbor base stations; and controlling a power level of an access probe with the provided compensation value.

### BRIEF DESCRIPTION OF THE DRAWINGS

Other aspects and advantages of the present invention will become apparent upon reading the following detailed description and upon reference to the drawings in which:

FIG. 1 is a diagram illustrating a general PN overlapping region;

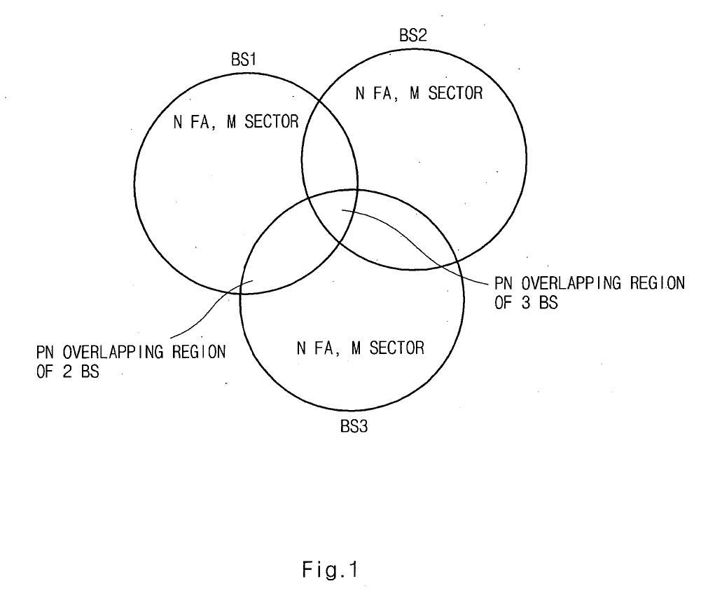

FIG. 2 is a diagram illustrating a wireless communication terminal having a power control function of an access probe using a neighbor set list according to an embodiment of the present invention;

FIG. 3 is a diagram illustrating a call setup rate of a wireless communication terminal having a power control function of an access probe using a neighbor set list according to an embodiment of the present invention;

FIG. 4 is a flow chart illustrating a method for controlling a power level of an access probe using a neighbor set list in a wireless communication terminal according to an embodiment of the present invention; and

FIG. 5 is a diagram illustrating a call process of a general wireless communication terminal.

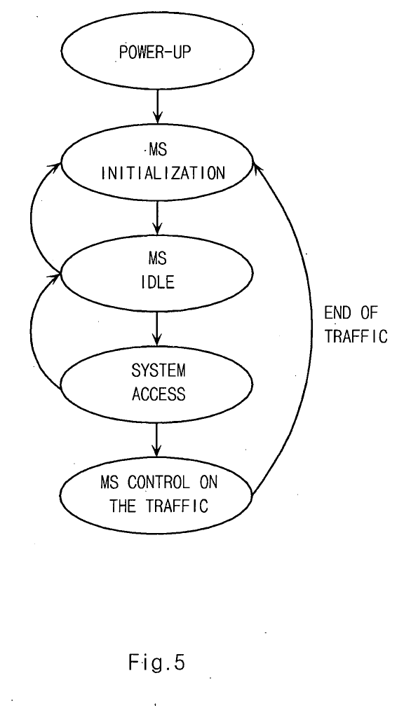

### DETAILED DESCRIPTION OF THE EXEMPLARY EMBODIMENTS

The present invention will be described in detail with reference to the accompanying drawings. Wherever possible, the same reference numbers will be used throughout the drawings to refer to the same or like parts.

According to an embodiment of the present invention, a wireless communication terminal includes a portable wireless communication terminal for transmitting and receiving voice, characters and image data through wireless communication such as a mobile communication terminal, a PCS (Personal Communication Service) terminal, a PDA (Personal Digital Assistant), a smart phone and a next-generation mobile communication (IMT-2000) terminal.

In addition to controlling a power level of an access probe according to IS-95A/B or CDMA2000 Spec, controlling according to an embodiment of the present invention is applied.

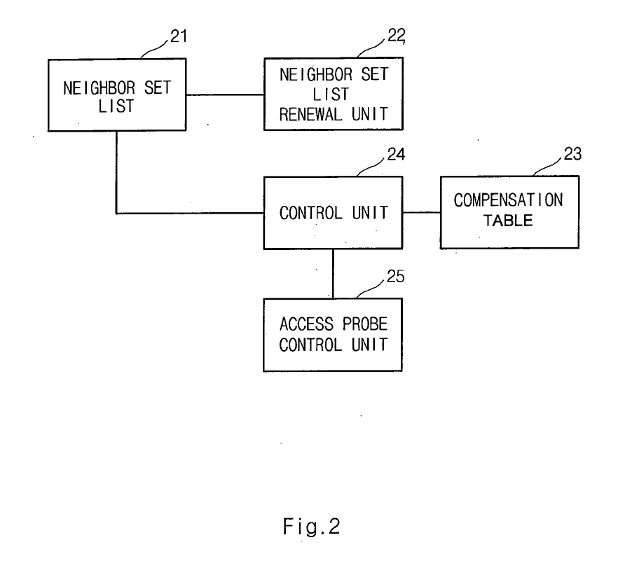

FIG. 2 is a diagram illustrating a wireless communication terminal having a power control function of an access probe using a neighbor set list according to an embodiment of the present invention.

Referring to FIG. 2, the wireless communication terminal having a power control function of an access probe using a neighbor set list comprises a neighbor set list 21, a neighbor set list renewal unit 22, a compensation table 23, a control unit 24 and an access probe control unit 25. The neighbor set list 21 records the number of neighbor base stations in a PN overlapping region. The neighbor set list renewal unit 22 renews the neighbor set list 21 in communication with a neighbor base station. The compensation table 23 stores a compensation value (power level) pwr_step corresponding to the number of neighbor base stations. The control unit 24 searches a compensation value corresponding to the number of neighbor base stations in the neighbor set list 21 through the compensation table 23. The access probe control unit 25 controls a power level of an access probe using the compensation value transmitted from the control unit 24.

A compensation value providing unit (not shown) includes the neighbor set list 21, the neighbor set list renewal unit 22 and the compensation table 23.

The control unit 24 controls the access probe control unit 25 to regulate a power level of the access probe as defined in IS-95A/B, CDMA200 Spec.

The compensation table 23 can store the compensation value corresponding to the number of neighbor base stations one by one, but the compensation table 23 may divide the number of neighbor base stations into groups to store the compensation value corresponding to each group.

The following table 1 shows compensation values corresponding to the number of neighbor base stations.

TABLE 1

| The number of neighbor base stations | Compensation value | |
|---|---|---|
| 4˜5 | 1.5 | dB |
| 6˜7 | 2 | dB |
| 8˜9 | 2.5 | dB |
| Over 10 | 3 | dB |

When the number of neighbor base stations is 3 or less, there is no compensation.

The compensation value may be set with an apparatus equipped with a DM (Diagnostic Monitor) program to measure and analyze electric wave environment which has been widely used in development of mobile stations or in test.

The neighbor set list renewal unit 22 includes a module for managing the strength of a pilot channel.

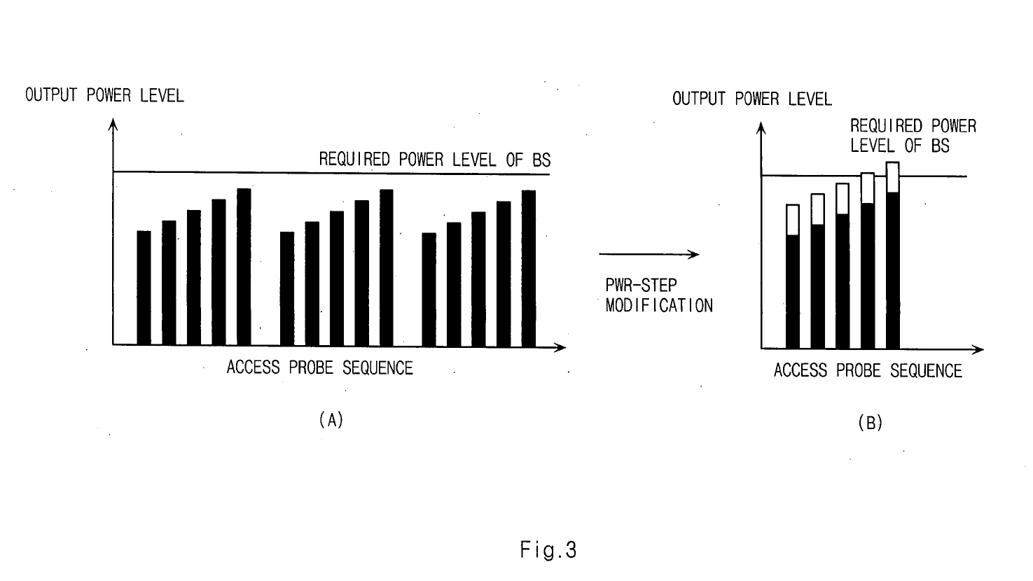

FIG. 3 is a diagram illustrating a call setup success rate of a wireless communication terminal having a power control function of an access probe using a neighbor set list according to an embodiment of the present invention.

FIG. 3(a) is a graph that illustrates the regulated power of the access probe as defined in the conventional IS-95A/B or CDMA2000 Spec. As shown in FIG. 3(a), the call setup is failed although the access probe sequences are outputted three times.

FIG. 3(b) is a graph illustrating a method for controlling a power level of an access probe using a neighbor set list according to an embodiment of the present invention. As shown in FIG. 3(b), the required power of the base station is satisfied in the fifth access attempt of the first access probe sequence so that the call setup is succeeded.

As a result, it is shown that the method according to the embodiment of the present invention requires only one access probe sequence for attempting an access probe although the conventional method requires three access probe sequence for attempting an access probe.

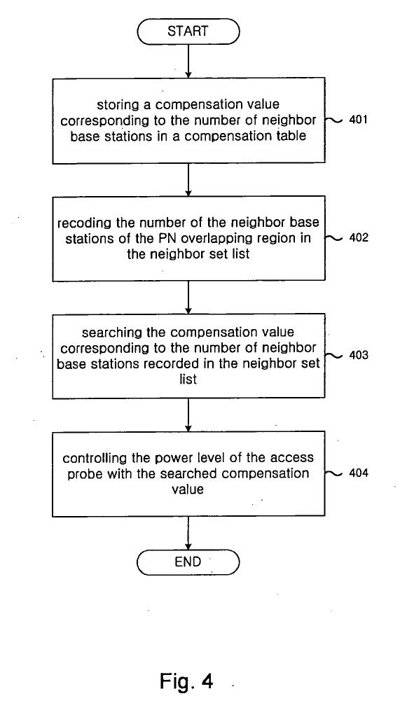

FIG. 4 is a flow chart illustrating a method for controlling a power level of an access probe using a neighbor set list in a wireless communication terminal according to an embodiment of the present invention.

First, a compensation value (power level) pwr_step corresponding to the number of neighbor base stations is stored in the compensation table 23 (401).

Then, the number of neighbor base stations of the PN (Pseudo Noise) overlapping region is recorded in the neighbor set list 21 (402).

Next, the compensation value corresponding to the number of neighbor base stations recorded in the neighbor set list 21 is searched in the compensation table 23 (403).

Thereafter, the power level of the access probe is controlled with the searched compensation value (404).

As described above, according to an embodiment of the present invention, a power level of an access probe is controlled with a compensation table for storing compensation value (power level) corresponding to the number of neighbor base stations and a neighbor set list for recording the number of neighbor base stations of a PN (Pseudo Noise) overlapping region interfered from the neighbor base stations, thereby increasing a call setup success rate.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. Thus, the embodiments were chosen and described in order to explain the principles of the invention and its practical application to enable one skilled in the art to utilize the invention in various embodiments and with various modifications as are suited to the particular use contemplated.

What is claimed is:

1. A wireless communication terminal having a power control function of an access probe using a neighbor set list, the terminal comprising:
a compensation value providing unit configured to provide a compensation value corresponding to the number of neighbor base stations;
a control unit configured to transmit the compensation value provided from the compensation value providing unit into an access probe control unit; and
an access probe control unit configured to control a power level of an access probe with the compensation value transmitted from the control unit.

2. The wireless communication terminal according to claim 1, wherein the compensation value providing unit comprises:
a neighbor set list configured to record the number of neighbor base stations;
a neighbor set list renewal unit configured to renew the neighbor set list in communication with the neighbor base station; and
a compensation value storage unit configured to store the compensation value corresponding to the number of the neighbor base stations.

3. The wireless communication terminal according to claim 2, wherein the neighbor set list renewal unit renews the neighbor set list in communication with a neighbor base station of a PN (Pseudo Noise) overlapping region.

4. The wireless communication terminal according to claim 2, wherein the compensation value storage unit stores the compensation value corresponding to the number of the neighbor base stations obtained from an apparatus equipped with a DM (Diagnostic Monitor) program.

5. A method for controlling output of an access probe using a neighbor set list in a wireless communication terminal, the method comprising:
providing a compensation value corresponding to the number of neighbor base stations; and
controlling a power level of an access probe with the provided compensation value.

6. The method according to claim 5, wherein the compensation value providing step comprises:
storing a compensation value corresponding to the number of neighbor base stations in a compensation table;
renewing the neighbor set list by recording the number of the neighbor base stations; and
providing the compensation value corresponding to the number of the neighbor base stations recorded in the neighbor set list.

7. The method according to claim 6, wherein the step of renewing the neighbor set list includes recording the number of neighbor base stations of a PN (Pseudo Noise) overlapping region in the neighbor set list.

8. The method according to claim 6, wherein the step of storing the compensation value includes storing the compensation value corresponding to the number of the neighbor base stations obtained from an apparatus equipped with a DM (Diagnostic Monitor) program.
